(19) United States
(12) Patent Application Publication
(10) Pub. No.: US 2026/0078040 A1
(43) Pub. Date: Mar. 19, 2026

(54) HEAT DISSIPATION APPARATUSES FOR MOLTEN GLASS IN PLATINUM CHANNEL AND METHODS THEREOF

(71) Applicant: CAIHONG DISPLAY DEVICES CO., LTD., Xianyang (CN)

(72) Inventors: Menglong WANG, Xianyang (CN); Hongrong HOU, Xianyang (CN); Wei YANG, Xianyang (CN); Canglong WANG, Xianyang (CN)

(73) Assignee: CAIHONG DISPLAY DEVICES CO., LTD., Xianyang (CN)

(21) Appl. No.: 19/398,019

(22) Filed: Nov. 23, 2025

Related U.S. Application Data
(63) Continuation-in-part of application No. PCT/CN2025/111264, filed on Jul. 29, 2025.

(30) Foreign Application Priority Data
Jul. 30, 2024 (CN) 202411033838.0

(51) Int. Cl. C03B 5/23; C03B 5/167; C03B 7/06

(52) U.S. Cl. CPC C03B 5/23; C03B 5/1675; C03B 7/06

(57) ABSTRACT

Disclosed is a heat dissipation apparatus and method for molten glass in a platinum channel. The apparatus includes an apparatus body and a control unit disposed on the apparatus body, the apparatus body includes a heat dissipation unit and a monitoring unit, and the monitoring unit and the heat dissipation unit are installed on a pipe section of the platinum channel. The heat dissipation unit includes an internal cooling assembly and an external air-guiding assembly, and the external air-guiding assembly is capable of connecting to an external cooling air supply device, so that the control unit controls a flow rate of the external cooling air supply device according to temperature data of the molten glass monitored by the monitoring unit, to control a temperature of the molten glass in the pipe section of the platinum channel. The internal cooling assembly includes a circulating cooling pipe disposed inside the platinum channel, the circulating cooling pipe is provided with an air inlet and an air outlet, pipe sections of the air inlet and the air outlet extend through and out of the platinum channel and are conductively connected to the external air-guiding assembly, the external air-guiding assembly is provided with an external connecting pipe, and the external connecting pipe is used for connecting to the external cooling air supply device.

### CROSS-REFERENCE TO RELATED APPLICATIONS

This application is a continuation-in-part application of International Application No. PCT/CN2025/111264, filed on Jul. 29, 2025, which claims priority to Chinese Patent Application No. 202411033838.0, filed on Jul. 30, 2024, the entire contents of each of which are hereby incorporated by reference.

### TECHNICAL FIELD

The present disclosure generally relates to the technical field of temperature control in substrate glass manufacturing, and in particular, to a heat dissipation apparatus for molten glass in a platinum channel and method thereof.

### BACKGROUND

As an important component in the display industry chain, substrate glass faces new technical requirements in its production with the continuous development of the new display industry toward larger sizes. For example, a furnace requires a higher melting efficiency and a more stable melting process, and a channel device requires greater heat dissipation capacity and superior clarification and homogenization capacity. Since heat dissipation itself is a process in which heat is sequentially transferred from inside to outside of the molten glass, a temperature inside the molten glass is always higher than that a temperature outside the molten glass. Further, the inside-outside temperature difference increases as a cooling time extends, adversely affecting uniformity control of the glass and potentially even leading to a decline in a quality of formed glass. For the channel device, on the premise that an overall layout of the existing device remains unchanged, as an environmental control capability has approached an upper limit, it is only possible to achieve a preset heat dissipation gradient by continuously lengthening the channel device to provide more heat dissipation time.

In the prior art, a cooling region is arranged outside of the platinum channel, thereby cooling the molten glass inside the platinum channel, achieving a certain heat dissipation and cooling effect. However, this manner performs cooling outside of the platinum channel. Since the molten glass is entirely contained within the platinum channel, the molten glass closer to a channel center is more difficult to cool quickly. Therefore, heat dissipation efficiency of this manner is not high enough, and it is relatively easy to form a large radial temperature difference in the molten glass within the platinum channel, which is not conducive to overall uniformity of the glass and affects the control of subsequent processes.

Therefore, it is desired to provide a heat dissipation apparatus for molten glass in a platinum channel and method thereof, which accelerates air circulation in a cooling pipe through an internal cooling assembly and an external air-guiding assembly of the heat dissipation apparatus to achieve high-speed cooling of the molten glass in the channel.

### SUMMARY

One or more embodiments of the present disclosure provide a heat dissipation apparatus for molten glass in a platinum channel. The heat dissipation apparatus comprises an apparatus body and a control unit disposed on the apparatus body. The apparatus body comprises a heat dissipation unit and a monitoring unit. The monitoring unit and the heat dissipation unit are installed on a pipe section of the platinum channel (1). The heat dissipation unit comprises an internal cooling assembly and an external air-guiding assembly. The external air-guiding assembly is capable of connecting to an external cooling air supply device, so that the control unit controls a flow rate of the external cooling air supply device according to temperature data of the molten glass monitored by the monitoring unit, to control a temperature of the molten glass in the pipe section of the platinum channel (1). The internal cooling assembly comprises a circulating cooling pipe (2) disposed inside the platinum channel (1). The circulating cooling pipe (2) is provided with an air inlet (24) and an air outlet (25). Pipe sections of the air inlet (24) and the air outlet (25) extend through and out of the platinum channel (1) and are conductively connected to the external air-guiding assembly. The external air-guiding assembly is provided with an external connecting pipe (33), and the external connecting pipe (33) is used for connecting to the external cooling air supply device.

One or more embodiments of the present disclosure provide a heat dissipation method for molten glass in a platinum channel. The method is applied to the heat dissipation apparatus for molten glass in the platinum channel as described above. The method comprises: installing the internal cooling assembly and the external air-guiding assembly on the platinum channel (1), checking tightness, checking integrity of the monitoring unit, and connecting the external air-guiding assembly to the external cooling air supply device; turning on the external cooling air supply device, and simultaneously controlling the monitoring unit and the control unit to operate; monitoring, by the monitoring unit, the temperature data of the molten glass in real time and uploading the temperature data to the control unit; and performing, by the control unit, calculation and analysis according to the temperature data, to control a switching status of a flow valve of the external cooling air supply device, so as to increase or decrease a circulation speed of cooling gas in the heat dissipation unit.

### BRIEF DESCRIPTION OF THE DRAWINGS

The present disclosure is further illustrated by way of exemplary embodiments, which is described in detail by means of the accompanying drawings. These embodiments are not limiting, and in these embodiments, the same numbering indicates the same structure, wherein:

FIG. 1 is a schematic diagram illustrating a structure of a heat dissipation apparatus for molten glass in a platinum channel according to some embodiments of the present disclosure;

FIG. 2 is a schematic diagram illustrating a structure of an internal cooling assembly according to some embodiments of the present disclosure;

FIG. 3 is a schematic diagram illustrating a detailed structure of an internal cooling assembly after installation according to some embodiments of the present disclosure;

FIG. 4 is a schematic diagram illustrating a structure of an end sealing cap according to some embodiments of the present disclosure;

FIG. 5 is a schematic diagram illustrating a partial structure of an air duct assembly according to some embodiments of the present disclosure;

FIG. 6 is a schematic diagram illustrating an assembly structure of a single apparatus body according to some embodiments of the present disclosure;

FIG. 7 is a schematic diagram illustrating an assembly structure of a plurality of apparatus bodies according to some embodiments of the present disclosure;

FIG. 8 is a flowchart illustrating an exemplary heat dissipation method for molten glass in a platinum channel according to some embodiments of the present disclosure;

FIG. 9 is a cross-sectional schematic diagram of cooling principle of the platinum channel according to some embodiments of the present disclosure;

FIG. 10 is another cross-sectional schematic diagram of the cooling principle of the platinum channel according to some embodiments of the present disclosure; and

FIG. 11 is another cross-sectional schematic diagram of the cooling principle of the platinum channel according to some embodiments of the present disclosure.

### DESCRIPTION OF REFERENCE NUMERALS

1, platinum channel; 2, circulating cooling pipe, 21, main cooling pipe, 22, branch cooling pipe, 23, end sealing cap, 24, air inlet, 25, air outlet; 3, air duct assembly, 31, annular pipe, 32, shunt pipe, 33, external connecting pipe; 4, refractory brick; 5, plug-in thermocouple; 6, welded thermocouple.

### DETAILED DESCRIPTION

To make the objectives, technical solutions, and advantages of the embodiments of the present disclosure more clear, the technical solutions in the embodiments of the present disclosure are clearly and completely described below with reference to the accompanying drawings in the embodiments of the present disclosure. Obviously, the described embodiments are some, but not all, embodiments of the present disclosure. Components of the embodiments of the present disclosure, which are generally described and illustrated in the accompanying drawings herein, may be arranged and designed in various different configurations.

Therefore, the following detailed description of the embodiments of the present disclosure provided in the accompanying drawings is not intended to limit the scope of the claimed present disclosure, but merely represents selected embodiments of the present disclosure. Based on the embodiments of the present disclosure, all other embodiments obtained by a person of ordinary skill in the art without creative efforts shall fall within the protection scope of the present disclosure.

It should be noted that similar reference numerals and letters denote similar items in the following accompanying drawings. Therefore, once an item is defined in one drawing, it does not need to be further defined and explained in subsequent drawings.

In the description of the embodiments of the present disclosure, it should be noted that if terms such as “upper”, “lower”, “horizontal”, and “inner” are used to indicate orientations or positional relationships, these are based on the orientations or positional relationships shown in the accompanying drawings, or the orientations or positional relationships in which the product of the present disclosure is usually placed when in use. These terms are used only to facilitate the description of the present disclosure and simplify the description, rather than to indicate or imply that the referred apparatus or element must have a specific orientation or be constructed and operated in a specific orientation. Therefore, these terms should not be construed as limiting the present disclosure. In addition, terms such as “first” and “second” are used only for distinguishing description and should not be construed as indicating or implying relative importance.

In addition, if the term “horizontal” appears, it does not mean that the component must be absolutely horizontal, but may be slightly inclined. For example, “horizontal” merely means that its direction is more horizontal relative to “vertical” and does not mean that the structure must be completely horizontal, but may be slightly inclined.

In the description of the embodiments of the present disclosure, it should also be noted that, unless otherwise explicitly specified and defined, if terms such as “set”, “install”, “connected”, and “connect” appear, they should be understood in a broad sense. For example, the connection may be a fixed connection, a detachable connection, or an integral connection. The connection may also be a mechanical connection, an electrical connection, or a direct connection. The connection may also be a direct connection, or an indirect connection through an intermediate medium, or an internal communication between two elements. A person of ordinary skill in the art may understand the specific meanings of the foregoing terms in the present disclosure according to specific situations.

Flowcharts are used in the present disclosure to illustrate the operations performed by a system according to embodiments of the present disclosure. It should be appreciated that the preceding or following operations are not necessarily performed in an exact sequence. Instead, steps may be processed in reverse order or simultaneously. Also, it is possible to add other operations to these processes or to remove a step or steps from these processes.

The embodiments of the present disclosure provide a structure of a heat dissipation apparatus for molten glass in a platinum channel. The heat dissipation apparatus can achieve heat dissipation balance from inside to outside, so that heat of the molten glass can be dissipated more quickly and a temperature difference between inside and outside is further reduced, improving an overall uniformity of the glass and providing a good basic condition for high-quality regulation of subsequent processes.

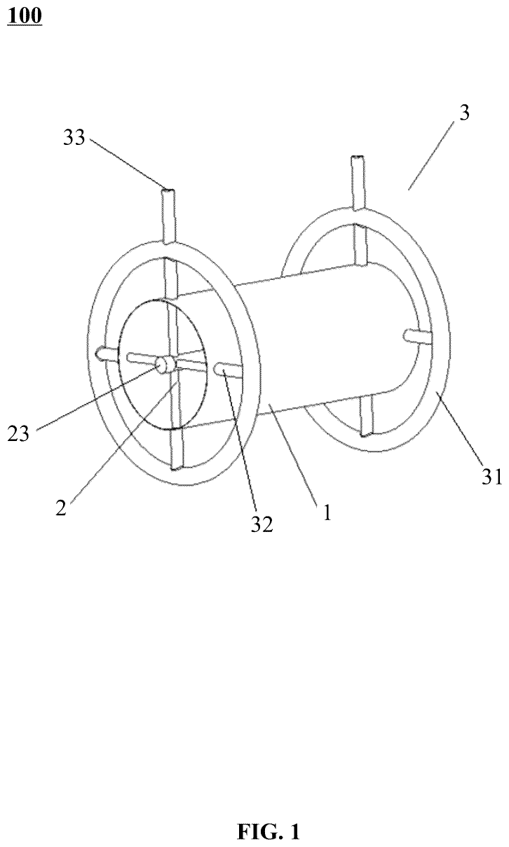

FIG. 1 is a schematic diagram illustrating a structure of a heat dissipation apparatus for molten glass in a platinum channel according to some embodiments of the present disclosure.

As shown in FIG. 1, in some embodiments, a heat dissipation apparatus 100 for molten glass in the platinum channel comprises an apparatus body and a control unit disposed on the apparatus body. The apparatus body comprises a heat dissipation unit and a monitoring unit. The monitoring unit and the heat dissipation unit are installed on a pipe section of the platinum channel (1). The heat dissipation unit comprises an internal cooling assembly and an external air-guiding assembly. The external air-guiding assembly is capable of connecting to an external cooling air supply device, so that the control unit controls a flow rate of the external cooling air supply device according to temperature data of the molten glass monitored by the monitoring unit, to control a temperature of the molten glass in the pipe section of the platinum channel (1). The internal cooling assembly comprises a circulating cooling pipe (2) disposed inside the platinum channel (1). The circulating cooling pipe (2) is provided with an air inlet (24) and an air outlet (25). Pipe sections of the air inlet (24) and the air outlet (25) extend through and out of the platinum channel (1) and are conductively connected to the external air-guiding assembly. The external air-guiding assembly is provided with an external connecting pipe (33). The external connecting pipe (33) is used for connecting to the external cooling air supply device.

The apparatus body refers to a key structural component in the heat dissipation apparatus 100 for molten glass in the platinum channel that directly exchanges heat with high-temperature molten glass and performs a core heat dissipation function. In some embodiments, the apparatus body comprises the heat dissipation unit and the monitoring unit.

The heat dissipation unit refers to a component in the apparatus body responsible for performing an active heat dissipation function. In some embodiments, the heat dissipation unit comprises the internal cooling assembly and the external air-guiding assembly.

The heat dissipation unit may receive cooling gas provided by the external cooling air supply device and accurately guide the cooling gas to the internal cooling assembly to ensure full and uniform contact between the cooling gas and the internal cooling assembly, thereby performing a cooling and heat dissipation process through direct or indirect heat exchange with an outer wall of the pipe section of the platinum channel.

The internal cooling assembly refers to a heat exchange device in the heat dissipation unit that directly contacts a pipe of the platinum channel and is used to absorb heat inside the pipe. In some embodiments, the internal cooling assembly comprises the circulating cooling pipe (2) disposed inside the platinum channel (1).

The circulating cooling pipe (2) refers to a pipe that provides a circulation path for the cooling gas. The circulating cooling pipe (2) is directly installed inside the platinum channel and immersed in the molten glass inside the platinum channel. The circulating cooling pipe (2) may transfer heat of the molten glass to the cooling gas flowing inside the pipe through a pipe wall.

In some embodiments, a material of the circulating cooling pipe (2) may be the same as a material of the platinum channel (1). For example, when the platinum channel (1) is made of pure platinum, the circulating cooling pipe (2) is also made of pure platinum (e.g., the same purity or composition) to achieve optimal thermal expansion matching.

In some embodiments of the present disclosure, the material of the circulating cooling pipe (2) is the same as the material of the platinum channel (1), which can effectively avoid stress concentration and structural deformation caused by thermal expansion mismatch of different materials at high temperature, significantly improving stability and service life of the apparatus. Meanwhile, it can ensure that the material of the circulating cooling pipe (2) does not contaminate the molten glass, maintaining high purity of the molten glass, thereby improving quality of glass products and production reliability.

In some embodiments, the circulating cooling pipe (2) is provided with the air inlet (24) and the air outlet (25).

The air inlet (24) refers to a cooling medium (cooling gas) inlet of the circulating cooling pipe (2). The air outlet (25) refers to a hot exhaust gas discharge port of the circulating cooling pipe (2). The cooling gas that has completed heat exchange may be discharged from the circulating cooling pipe (2) through the air outlet (25). The air inlet (24) and the air outlet (25) extend through and out of the platinum channel and are conductively connected to the external air-guiding assembly.

In some embodiments, the air inlet and the air outlet may be made of stainless steel materials, for example, 304 stainless steel or 316 stainless steel. In some embodiments, the air inlet and the air outlet may also be made of materials other than stainless steel, which is not limited herein.

The cooling gas refers to a carrier provided by the external cooling air supply device for performing heat exchange. The cooling gas flows through the external air-guiding assembly and the internal cooling assembly (e.g., the circulating cooling pipe) and carries away heat of the molten glass during this process. In some embodiments, considering that the platinum channel operates at a high temperature above 1500° C., to protect the platinum and suppress high-temperature oxidation, the cooling gas may be a temperature-adjustable inert gas, for example, nitrogen or argon.

In some embodiments of the present disclosure, an air flow cooling manner is adopted. Considering that internal structures are all made of the platinum-rhodium alloy, the temperature of the molten glass is above 1500° C., and there is a problem of platinum oxidation and volatilization, therefore, in an actual cooling gas solution, a temperature-adjustable inert gas, for example, nitrogen or argon, is selected, which can protect the platinum, suppress its internal high-temperature oxidation reaction, and prolong the service life of the apparatus.

The external air-guiding assembly refers to a component that delivers the cooling gas provided by the external cooling air supply device to the internal cooling assembly. In some embodiments, the external air-guiding assembly is provided with the external connecting pipe (33). The external connecting pipe (33) is used for connecting to the external cooling air supply device. In some embodiments, a material of the external air-guiding assembly may include two parts: the stainless steel and the platinum-rhodium alloy. That is, an external structure of the external air-guiding assembly is made of the stainless steel, and an internal part that contacts the platinum channel is made of the platinum-rhodium alloy.

The external connecting pipe (33) refers to a pipe that connects the external cooling air supply device to the external air-guiding assembly. The external connecting pipe (33) may receive the cooling gas transmitted by the external cooling air supply device.

The external cooling air supply device refers to a device installed outside the heat dissipation apparatus (100) for molten glass in the platinum channel and capable of generating and providing a controllable flow rate of cooling gas. For example, the external cooling air supply device may be a compressor or an inert gas (e.g., nitrogen or argon) supply system.

In some embodiments, a flow valve may be installed on the external cooling air supply device, to achieve flow control of the external air-guiding assembly by the control unit.

The monitoring unit refers to a component configured to collect relevant data of the heat dissipation unit.

In some embodiments, monitoring data collected by the monitoring unit comprises the temperature data of the molten glass. The temperature data of the molten glass refers to real-time temperature data of the molten glass in the platinum channel collected by the monitoring unit. In some embodiments, the monitoring unit may comprise a temperature sensor. For example, the temperature sensor (e.g., a thermocouple or a platinum resistor) may be installed at a specific position of the platinum channel to continuously measure actual temperature of the molten glass.

In some embodiments, the monitoring unit uploads the collected monitoring data to the control unit. In some embodiments, in addition to the temperature data of the molten glass, the monitoring data collected by the monitoring unit may further comprise operating parameters (e.g., a real-time flow rate, a pressure) of the external cooling air supply device and auxiliary data (e.g., an environment temperature). For example, the monitoring unit may further comprise a flow meter, a pressure gauge, or the like.

The platinum channel (1) refers to a sealed pipe made of platinum material located between a melting furnace and a forming device in a glass production line. The platinum channel (1) is capable of performing precise temperature control, homogenization, and clarification on molten glass flowing in the platinum channel (1). The platinum channel (1) is a precisely controlled conveying pipe. Through an advanced heating and cooling system, precise temperature adjustment at a “millisecond level” can be performed on the molten glass flowing in the platinum channel (1). During the flow process of the molten glass, there may be slight non-uniformity in chemical composition or temperature inside the molten glass. Through a special structural design of the platinum channel (1) (e.g., a stirrer or a settling zone), the composition and temperature of the molten glass are further mixed uniformly, which can eliminate defects such as streaks and stones and ensure a pure and uniform texture of a final product. During a high-temperature melting process, many tiny bubbles remain in the molten glass. The platinum channel (1) provides a continuous high-temperature environment and may include a specific “clarification zone” to allow these bubbles sufficient time to float up, burst, and be discharged, thereby making the molten glass clear and transparent without any bubbles.

The control unit refers to a component configured to receive signals, perform logical judgments, and issue control instructions to other devices. In some embodiments, the control unit may be a processor.

The processor may process data and/or information obtained from other devices or system components. The processor may execute program instructions based on the data, the information, and/or processing results to perform one or more functions described in the present disclosure. In some embodiments, the processor may include one or more sub-processing devices (e.g., a single-core processing device or a multi-core multi-chip processing device). Merely by way of example, the processor may include a central processing unit (CPU), a controller, a microprocessor, or any combination thereof. In some embodiments, the processor may include a plurality of modules. Different modules may be configured to execute different program instructions respectively.

In some embodiments, the external air-guiding assembly is capable of connecting to the external cooling air supply device, so that the control unit controls the flow rate of the external cooling air supply device based on the temperature data of the molten glass monitored by the monitoring unit, to control a temperature of the molten glass in the pipe section of the platinum channel (1).

The flow rate of the external cooling air supply device refers to a volume or mass of the cooling gas generated by the external cooling air supply device and delivered to the internal cooling assembly via the external air-guiding assembly per unit time.

In some embodiments, the control unit performs a logical judgment based on received monitoring data (e.g., the temperature data of the molten glass) and generates a corresponding control instruction. For example, the control unit may preset a target temperature value, calculate a required flow adjustment amount of the cooling gas based on a difference between the temperature data of the molten glass in the monitoring data and the target temperature value via a control algorithm (e.g., a proportional-integral-derivative control algorithm, i.e., a PID algorithm), and generate the control instruction. The control unit sends the generated control instruction to the external cooling air supply device, thereby adjusting the flow rate of the cooling gas provided by the external cooling air supply device.

In some embodiments, the control unit may comprise a distributed control system. The distributed control system controls the flow rate of the external cooling air supply device based on the monitoring data uploaded by the monitoring unit.

For example, the distributed control system comprises a plurality of controllers or processing units that cooperate with each other. The controllers or the processing units may be distributed at different physical locations.

In some embodiments, the control unit may also be implemented via other non-distributed architectures, e.g., using a single-chip microcomputer or a centralized controller to control the system.

In some embodiments of the present disclosure, by combining the distributed control system with the monitoring unit and the external cooling air supply device, it can achieve refined and automated management of a heat dissipation process of the platinum channel, which can improve the quality of the molten glass, stabilize the production process, and enhance the operating efficiency of the apparatus.

In some embodiments, the internal cooling assembly and the external air-guiding assembly are disposed on the platinum channel (1), and the external air-guiding assembly is provided with the external cooling air supply device, combined with the distributed control system and the monitoring unit, the temperature of the molten glass in the platinum channel (1) is controlled.

The platinum channel (1) of the present disclosure is a main pipe of a substrate glass platinum channel, with the heat dissipation apparatus on the basis of an original platinum channel. Therefore, in some embodiments, a local structure of the original platinum channel needs to be redesigned to include a functional segment. Four welding holes distributed at 90° are arranged at two ends of the functional segment for assembly welding with the internal circulating cooling pipe (2) to form an integral structure.

In some embodiments, the circulating cooling pipe (2) is welded to the platinum channel (1) inside the platinum channel (1) via cross-shaped branch pipes at two ends thereof. Without affecting a bulk fluidity of the molten glass inside the platinum channel (1), a cooling air flow is brought into the hottest central region of the molten glass.

In some embodiments, an overall structure of the circulating cooling pipe (2) may be made of a same material as the platinum channel (1) or a platinum-rhodium alloy with a higher content. A content (mass percentage) range of a rhodium element affecting structural strength and high-temperature resistance may be 10% to 20%. In actual operation, materials of different compositions may also be selected for the circulating cooling pipe (2) according to different temperature ranges of the molten glass. For example, when the temperature of the molten glass reaches 1600° C. or above, a rhodium content in the circulating cooling pipe (2) needs to reach 20%. As another example, when the temperature of the molten glass is 1500° C. or below, the rhodium content in the circulating cooling pipe (2) may range from 10% to 15%.

In some embodiments of the present disclosure, beneficial effects of the heat dissipation apparatus for molten glass in the platinum channel include but are not limited to the follows.

In some embodiments of the present disclosure, by combining the internal cooling assembly and the external air-guiding assembly, precise control of the temperature of the molten glass in the platinum channel can be achieved, which helps improve quality control during a glass production process. Using the cooling gas provided by the external cooling air supply device, heat dissipation is performed directly on the molten glass through the internal circulating cooling pipe, improving heat dissipation efficiency. The control unit automatically adjusts the flow rate of the external cooling air supply device based on data from the monitoring unit, achieving intelligent and automated temperature control.

Through the above structural design, embodiments of the present disclosure may be applied in the thin-film transistor liquid crystal display (TFT-LCD) substrate glass industry. Primarily targeting process regulation of the platinum channel, based on an attribute characteristic of a cross-sectional temperature of the molten glass being higher inside and lower outside, the internal cooling assembly penetrating an interior of the molten glass and the external air-guiding assembly are designed, and then are connected to the external cooling air supply device, which rapidly removes heat from inside of the molten glass via an air blowing manner, thereby achieving a purpose of rapid and uniform heat dissipation for the entire molten glass. This effectively mitigates drawbacks of an existing device that trade space for capability, provides favorable conditions for subsequent processes and glass treatment, offers certain technical support for the development of substrate glass towards higher forming quality, and has good practical significance.

In some embodiments of the present disclosure, problems existing in the prior art and related phenomena in actual working conditions are fully considered, a cooling region is moved from an exterior to an interior of the molten glass without causing excessive impact on a normal flow of the molten glass. Placing a cold source inside the high-temperature molten glass requires a reliable structural design. For molten glass as high as 1500° C., general structures or auxiliary devices are difficult to operate for a long term. Therefore, it is necessary to adopt a same material as a main body and combine with a matched supporting structure, so that this cooling solution is capable of operating stably inside the molten glass for a long term, thereby achieving a heat dissipation balance from inside to outside. This allows heat of the molten glass to be dissipated more quickly, improves an overall uniformity of the glass, provides a good foundation for high-quality regulation of subsequent processes, and enables further development of substrate glass manufacturing capability.

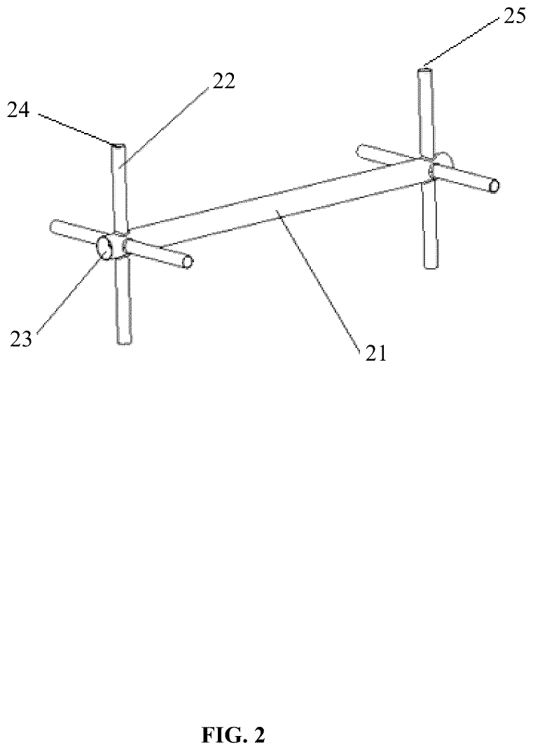

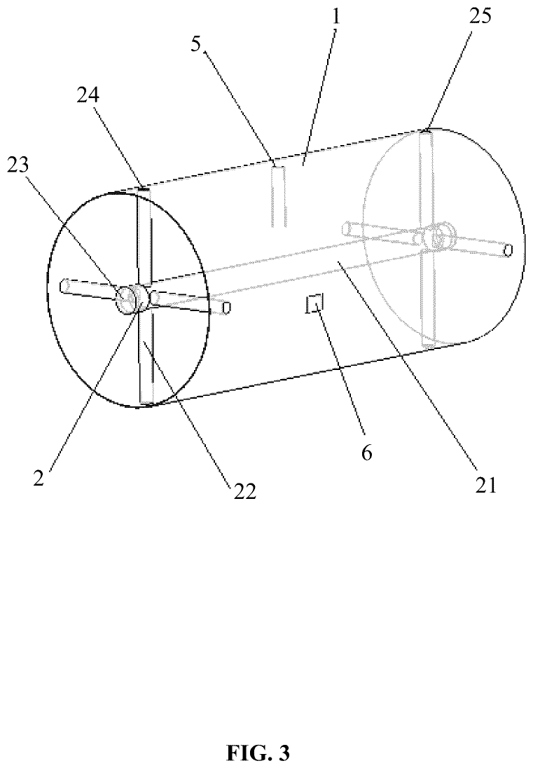

FIG. 2 is a schematic diagram illustrating a structure of an internal cooling assembly according to some embodiments of the present disclosure. FIG. 3 is a schematic diagram illustrating a detailed structure of an internal cooling assembly after installation according to some embodiments of the present disclosure.

In some embodiments, the circulating cooling pipe (2) comprises a main cooling pipe (21) and a branch cooling pipe (22). As shown in FIGS. 2 and 3, the circulating cooling pipe (2) comprises a main cooling pipe (21) arranged inside the platinum channel (1) along an axial direction. The main cooling pipe (21) is conductively connected to at least one branch cooling pipe (22) at positions close to two ends of the main cooling pipe (21). The air inlet (24) is disposed at an end of the branch cooling pipe (22) away from the main cooling pipe (21). The branch cooling pipe (22) extends through and out of an outer wall of the platinum channel (1).

The main cooling pipe (21) refers to a main functional section in the circulating cooling pipe. A radial direction of the main cooling pipe (21) is completely consistent with a flow direction of the molten glass. The main cooling pipe (21) is distributed in a central region of the molten glass and penetrates the entire molten glass. An overall length of the main cooling pipe (21) may be determined based on comprehensive consideration of structure and function.

In some embodiments, the overall length of the main cooling pipe (21) may be in a range of 1000 mm to 1600 mm. An excessively long length may cause deformation due to lack of support in the middle. In some embodiments, the overall length of the main cooling pipe (21) may be in a range of 1000 mm to 1500 mm, 1000 mm to 1400 mm, 1000 mm to 1300 mm, 1100 mm to 1600 mm, 1200 mm to 1600 mm, 1300 mm to 1600 mm, 1100 mm to 1500 mm, 1200 mm to 1400 mm, or the like.

In some embodiments, a wall thickness of the main cooling pipe (21) may be designed as 1.5 mm, thereby providing structural strength for long-term stable operation. In some embodiments, the wall thickness of the main cooling pipe (21) may be in a range of 1.4 mm to 1.6 mm, 1.3 mm to 1.7 mm, or the like.

In some embodiments, an inner diameter of the main cooling pipe (21) is designed according to requirements of flow rate and cooling capacity. For example, the inner diameter of the main cooling pipe (21) may be in a range of 20 mm to 30 mm. As another example, the inner diameter of the main cooling pipe (21) may be in a range of 20 mm to 30 mm, 23 mm to 30 mm, 25 mm to 30 mm, 20 mm to 28 mm, 20 mm to 25 mm, 23 mm to 28 mm, or the like.

The branch cooling pipe (22) refers to a cooling gas shunt pipe in the circulating cooling pipe (2) that connects the main cooling pipe (21) to the air inlet (24) or the air outlet (25).

In some embodiments, a material of the branch cooling pipe (22) may be the same as a material of the main cooling pipe (21). In some embodiments, the branch cooling pipes (22) may be divided into two groups and welded to two ends of the main cooling pipe (21) at a distance of 50 mm from ends of the main cooling pipe (21). Angles of the branch cooling pipes (22) in the two groups are consistent. In some embodiments, a length of the branch cooling pipe (22) may be the same as a radius of the platinum channel (1). A wall thickness of the branch cooling pipe (22) may be the same as a wall thickness of the main cooling pipe (21). The inner diameter of the branch cooling pipe (22) may be in a range of 10 mm to 15 mm. A pipe body material of the branch cooling pipe (22) may be the same as a pipe body material of the main cooling pipe (21). For example, the inner diameter of the branch cooling pipe (22) may be in a range of 10 mm to 15 mm, 11 mm to 15 mm, 12 mm to 15 mm, 10 mm to 14 mm, 10 mm to 13 mm, 11 mm to 14 mm, or the like.

In some embodiments, as shown in FIG. 2 and FIG. 3, four branch cooling pipes (22) may be provided. The four branch cooling pipes (22) are arranged at intervals along a circumferential direction of the main cooling pipe (21). For example, the four branch cooling pipes (22) may be uniformly distributed along the circumferential direction at a same axial position of the main cooling pipe (21), i.e., one branch cooling pipe (22) is arranged approximately every 90 degrees.

In some embodiments, a number of the branch cooling pipes (22) may be set to three, five, six, etc., according to specific heat dissipation requirements and structural space limitations.

In some embodiments of the present disclosure, by arranging four branch cooling pipes (22) at intervals along the circumferential direction of the main cooling pipe (21), it can ensure that the cooling gas acts uniformly and efficiently on an outer wall of the main cooling pipe (21), thereby carrying away heat transferred from the platinum channel and improving heat dissipation efficiency.

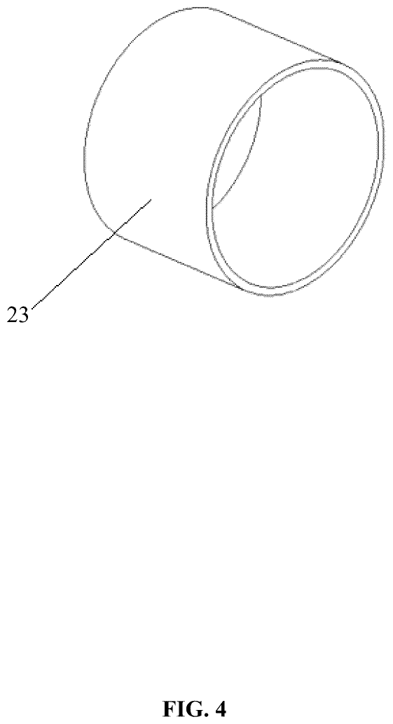

FIG. 4 is a schematic diagram illustrating a structure of an end sealing cap according to some embodiments of the present disclosure.

As shown in FIG. 4, in some embodiments, two ends of the main cooling pipe (21) are provided with end sealing caps (23). The end sealing caps (23) are used for sealing the main cooling pipe (21) along the axial direction.

The main cooling pipe (21), the branch cooling pipes (22), the end sealing caps (23) at the two ends of the main cooling pipe (21), and the air inlet (24) and the air outlet (25) provided on the branch cooling pipes (22) form the circulating cooling pipe (2) whose main function is cooling.

The end sealing cap (23) refers to a detachable sealing cover member used for sealing an end opening of the circulating cooling pipe (2). The end sealing cap (23) needs to have characteristics such as reliable tightness and corrosion resistance. For example, a material of the end sealing cap (23) may be the stainless steel, brass, special plastic, etc.

In some embodiments, the main cooling pipe (21), the branch cooling pipes (22), and the end sealing caps (23) of the entire circulating cooling pipe (2) may be sealed by welding. After welding is completed, an air tightness test is performed to ensure absolute sealing of the entire circulating cooling pipe (2), avoiding air leakage and bubble-related defects and problems in the molten glass.

In some embodiments, a material of the end sealing cap (23) may be the same as a material of the main cooling pipe (21). A number of the end sealing caps may be two. In some embodiments, an inner diameter of the end sealing cap (23) may be matched with an outer diameter of the main cooling pipe for installation. A depth of the end sealing cap (23) may be 40 mm. For example, the depth of the end sealing cap (23) may be in range of 30 mm to 50 mm, 35 mm to 50 mm, 30 mm to 45 mm, 35 mm to 45 mm, or the like. In some embodiments, an end of the end sealing cap (23) may adopt an arc-shaped design. A wall thickness of the end sealing cap (23) may be 1.5 mm. For example, the wall thickness of the end sealing cap (23) may be in a range of 1.0 mm to 2.0 mm, 1.2 mm to 2.0 mm, 1.0 mm to 1.8 mm, 1.2 mm to 1.8 mm, or the like.

In some embodiments of the present disclosure, the end sealing caps (23) are installed at the two ends of the main cooling pipe (21) and sealed by welding, which can restrict the cooling gas from leaking out from the two ends of the main cooling pipe (21), thereby improving tightness and cooling efficiency.

In some embodiments, as shown in FIG. 3, the monitoring unit may further comprise at least one plug-in thermocouple (5) and at least one welded thermocouple (6) disposed on the platinum channel (1).

The plug-in thermocouple (5) refers to a device that extends into the platinum channel and measures the temperature of the molten glass by direct contact.

The welded thermocouple (6) refers to a device that is fixed on a surface of the outer wall of the platinum channel and measures the temperature of the molten glass by indirect contact.

The plug-in thermocouple (5) may directly measure a core temperature of the molten glass, ensuring precise control of homogenization and clarification processes of the molten glass. Meanwhile, the welded thermocouple (6) may monitor a surface temperature of the outer wall of the platinum channel (1), helping to evaluate a heat dissipation effect, identify overheating regions, and provide early warning regarding a structural condition of a channel wall.

For example, the plug-in thermocouple (5) and the welded thermocouple (6) may be deployed at different key positions along the platinum channel (1) (e.g., an inlet, a middle section, and an outlet) to provide comprehensive temperature information, supporting precise temperature control and fault diagnosis.

In some embodiments, the monitoring unit may be further equipped with temperature sensors in various other ways to obtain required temperature data. For example, the monitoring unit may be equipped with an infrared thermometer or a thermocouple array.

In some embodiments of the present disclosure, the monitoring unit can accurately measure a temperature of a glass core in the platinum channel (1) through the plug-in thermocouple (5) and the welded thermocouple (6). Meanwhile, the heat dissipation effect and channel health are monitored, thereby controlling an entire cooling process of the molten glass.

In some embodiments, the heat dissipation apparatus for the molten glass in the platinum channel may further comprise a grating sensor or an infrared array sensor, cooperating with the plug-in thermocouple (5) to obtain the temperature data. For example, the monitoring unit may comprise the grating sensor or the infrared array sensor.

The grating sensor refers to a sensor that utilizes an optical principle and a Moiré fringe technique to detect mechanical displacement. In some embodiments, the grating sensor may be a sapphire grating sensor, which has high temperature resistance. In some embodiments, the grating sensor may be a Fiber Bragg Grating (FBG).

The infrared array sensor refers to a sensor that is capable of performing non-contact temperature detection (e.g., temperature data of molten glass) based on an infrared radiation principle.

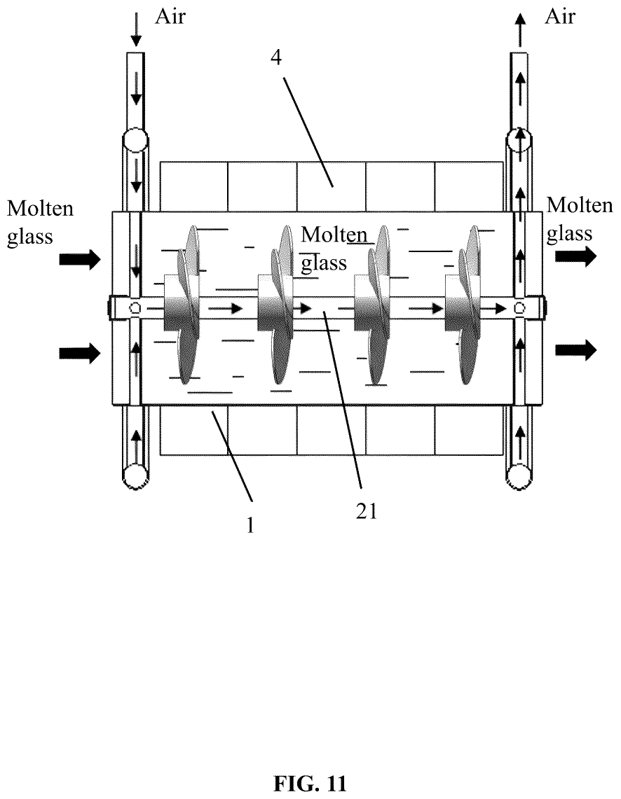

In some embodiments, the grating sensor or the infrared array sensor may be disposed on an outer wall of a main cooling pipe or a flow guide vane. More descriptions regarding the flow guide vane may be found in FIG. 11 and related descriptions thereof.

In some embodiments, the grating sensor or the infrared array sensor may also be disposed inside the circulating cooling pipe for monitoring a temperature of the cooling gas at different locations.

In some embodiments of the present disclosure, through the arrangements of the grating sensor or the infrared array sensor, combined with the plug-in thermocouple (5), it can obtain more comprehensive and accurate temperature information of the molten glass, providing data support for the control unit.

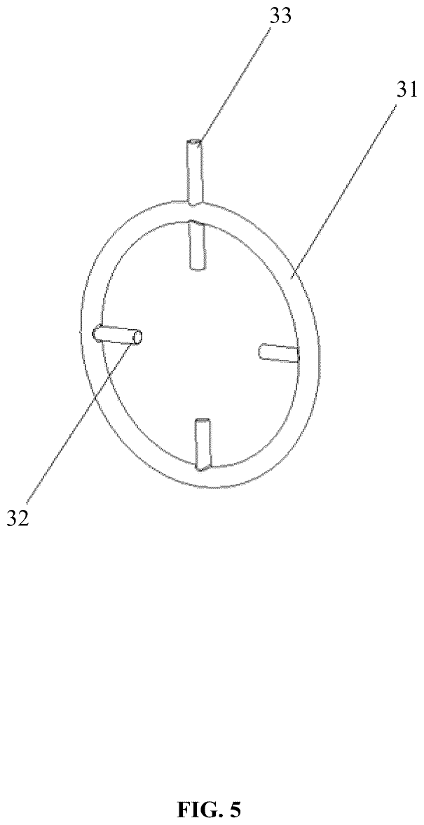

FIG. 5 is a schematic diagram illustrating a partial structure of an air duct assembly according to some embodiments of the present disclosure.

As shown in FIG. 5, in some embodiments, the external air-guiding assembly is a core auxiliary structure. The external air-guiding assembly comprises an air duct assembly (3). The air duct assembly (3) comprises two annular pipes (31), and each of the two annular pipes (31) is provided with shunt pipes (32) along a radial direction of the annular pipe (31). The shunt pipes (32) located at the two annular pipes (31) are conductively connected to the air inlet (24) and the air outlet (25) respectively. Each of the two annular pipes (31) is provided with the external connecting pipe (33) along a side wall of the annular pipe (31).

The air duct assembly (3) refers to a pipe assembly used for guiding gas flow.

The annular pipe (31) refers to a pipe member having an annular structure for carrying or guiding fluid.

In some embodiments, a material of the annular pipe (31) may be 316 stainless steel. An annular diameter of the annular pipe (31) may be related to a diameter of the platinum channel (1). For example, the annular diameter of the annular pipe (31) may be 150 mm to 300 mm larger than the diameter of the platinum channel (1), thereby ensuring that the two annular pipes (31) are located outside refractory material of an entire channel to maintain a safe ambient temperature. Operating environment of the annular pipe (31) has a temperature of about 300° C.

In some embodiments, a cross-sectional diameter of a pipe body of the annular pipe (31) may be 30 mm, which can ensure sufficient gas residence time. For example, the cross-sectional diameter of the pipe body of the annular pipe (31) may be in a range of 10 mm to 50 mm, 10 mm to 40 mm, 20 mm to 50 mm, 20 mm to 40 mm, or the like. A wall thickness of the annular pipe (31) may be 2.5 mm to meet strength requirements. For example, the wall thickness of the annular pipe (31) may be in a range of 1.0 mm to 4.0 mm, 1.5 mm to 4.0 mm, 2.0 mm to 4.0 mm, 1.0 mm to 3.5 mm, 1.0 mm to 3.0 mm, 2.0 mm to 3.5 mm, 2.0 mm to 3.0 mm, or the like.

The shunt pipe (32) refers to a pipe member that branches off from the annular pipe (31) and is used for guiding fluid to be shunted to the circulating cooling pipe (2).

In some embodiments, the shunt pipe (32) may be made of the platinum-rhodium alloy. The shunt pipe (32) may be connected to the annular pipe (31) via threads or a flange. In some embodiments, the shunt pipe (32) may be connected to an internal branch cooling pipe (22) through four holes on the platinum channel. A connection manner between the shunt pipe (32) and the branch cooling pipe (22) may also adopt a flange form, and sealing needs to be ensured.

In some embodiments, a pipe diameter of the shunt pipe (32) may be 20 mm, and a wall thickness of the shunt pipe (32) may be 2.0 mm. In some embodiments, the pipe diameter of the shunt pipe (32) may be in a range of 10 mm to 30 mm, 15 mm to 30 mm, 10 mm to 25 mm, 15 mm to 25 mm, or the like, and the wall thickness of the shunt pipe (32) may be in a range of 1.0 mm to 3.0 mm, 1.5 mm to 3.0 mm, 1.0 mm to 2.5 mm, 1.5 mm to 2.5 mm, or the like.

In some embodiments, a material of the external connecting pipe (33) may be the same as a material of the annular pipe. A pipe diameter of the external connecting pipe (33) may be 20 mm. In some embodiments, the pipe diameter of the external connecting pipe (33) may be in a range of 10 mm to 30 mm, 15 mm to 30 mm, 10 mm to 25 mm, 15 mm to 25 mm, or the like.

In some embodiments, the external connecting pipe (33) is externally connected to an external cooling air supply device. The external cooling air supply device provides compressed gas with an adjustable temperature. The flow rate of the external cooling air supply device is controlled by a flow valve. A switching status of the flow valve is controlled by the control unit (e.g., the distributed control system).

In some embodiments of the present disclosure, the heat dissipation apparatus for the molten glass in the platinum channel achieves multiple improvements in uniformity, system stability, maintenance simplicity, and design modularity through the synergistic effect of pressure equalization by the annular pipe and flow guidance by the shunt pipe.

In some embodiments, a plurality of the apparatus body are provided. The plurality of apparatus bodies are arranged along the axial direction of the platinum channel (1).

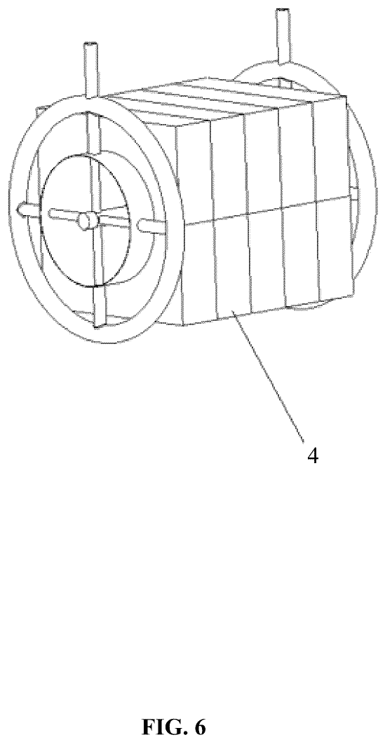

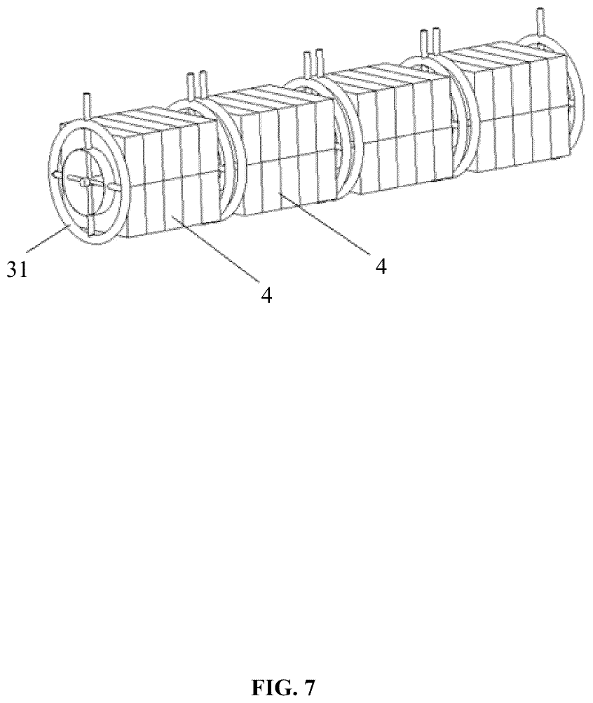

FIG. 6 is a schematic diagram illustrating an assembly structure of a single apparatus body according to some embodiments of the present disclosure. FIG. 7 is a schematic diagram illustrating an assembly structure of a plurality of apparatus bodies according to some embodiments of the present disclosure.

In some embodiments, as shown in FIG. 6, the single apparatus body and the platinum channel (1) may be placed as a whole in refractory material. External refractory bricks (4) cover an exterior of the platinum channel (1), serving to seal and support the platinum channel (1).

In some embodiments, as shown in FIG. 7, in practical use, considering apparatus size and the need for different draw rates, different sizes and quantities of apparatus bodies are also designed. A plurality of apparatus bodies are arranged at intervals along the platinum channel (1).

In some embodiments, the control unit (e.g., the distributed control system) may independently or collectively control flow rates of the plurality of apparatus bodies, so that a flow rate of the molten glass in the platinum channel (1) is controlled within a range of 600 kg/h to 1500 kg/h.

In some embodiments of the present disclosure, since a length of the platinum channel (1) may vary, heat dissipation control for a longer platinum channel (1) can be achieved by providing the plurality of apparatus bodies and connection manners thereof.

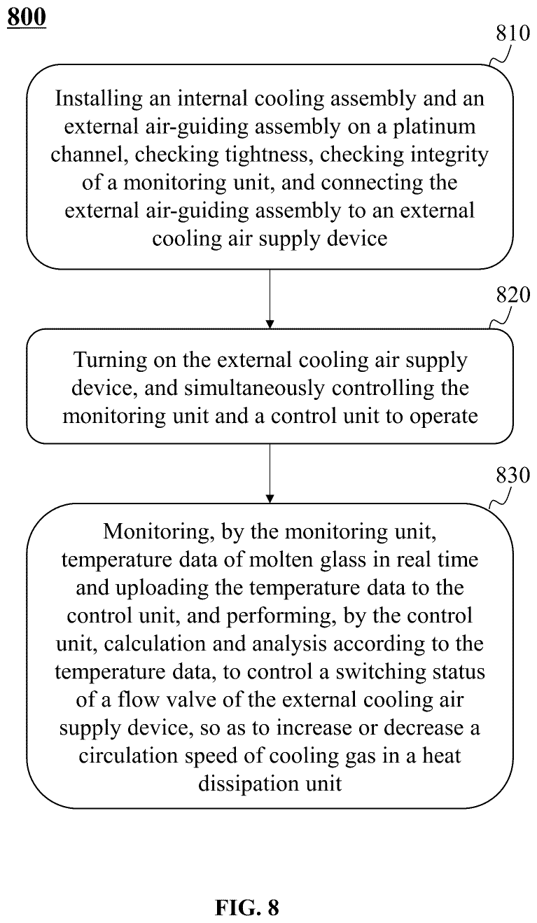

FIG. 8 is a flowchart illustrating an exemplary heat dissipation method for molten glass in a platinum channel according to some embodiments of the present disclosure.

In some embodiments, based on the heat dissipation apparatus for the molten glass in the platinum channel according to any embodiment of the present disclosure, the present disclosure provides a heat dissipation method for the molten glass in the platinum channel. As shown in FIG. 8, process 800 includes the following operations. In some embodiments, the process 800 may be executed by the heat dissipation apparatus 100 for the molten glass in the platinum channel (e.g., the control unit) or by operating personnel.

In 810, an internal cooling assembly and an external air-guiding assembly are installed on the platinum channel (1), tightness is checked, integrity of a monitoring unit is checked, and the external air-guiding assembly is connected to an external cooling air supply device.

In some embodiments, the internal cooling assembly may be installed inside or on an outer wall of the platinum channel (1) by welding or close fitting to efficiently absorb heat. The internal cooling assembly may have an annular structure and be integrated with the platinum channel. For example, the internal cooling assembly comprises the circulating cooling pipe (2) disposed inside the platinum channel (1). The external air-guiding assembly connects the external cooling air supply device to the internal cooling assembly. For example, the external air-guiding assembly comprises the external connecting pipe (33). For example, a connection between the external air-guiding assembly and the external cooling air supply device and the internal cooling assembly may adopt a flange connection or a threaded connection to ensure tightness of a gas flow path.

After installation is completed, a tightness check is performed on the entire apparatus to prevent leakage of cooling gas or intrusion of external gas. For example, precise detection may be performed using a pressure decay test or a helium mass spectrometer leak detector. Simultaneously, the integrity of the monitoring unit is checked to ensure that all temperature sensors (e.g., at least one plug-in thermocouple (5) and at least one welded thermocouple (6) configured on the platinum channel (1)) and circuit connections thereof are normal and functionally usable.

In some embodiments, the installation, connection, and inspection operations may also be implemented through various other automated or manual means to ensure that an initial state of the heat dissipation apparatus 100 for molten glass in the platinum channel meets operational requirements.

In 820, the external cooling air supply device is turned on, and simultaneously the monitoring unit and the control unit are controlled to operate.

In some embodiments, by starting the external cooling air supply device, the external cooling air supply device may begin generating and delivering the cooling gas. For example, the external cooling air supply device may be started via a remote instruction or a local button. The external cooling air supply device may provide inert gas with an adjustable temperature.

In some embodiments, the monitoring unit is powered on and begins collecting data, and the control unit enters a standby or automatic control mode after starting. In the automatic control mode, the control unit may automatically execute the heat dissipation process according to a preset program.

In some embodiments, the external cooling air supply device, the monitoring unit, and the control unit may also be started synchronously via the remote instruction or the local button, or the control unit may be started first, and then the external cooling air supply device and the monitoring unit may be started via the control unit.

In 830, the monitoring unit monitors temperature data of the molten glass in real time and uploads the temperature data to the control unit. The control unit performs calculation and analysis according to the temperature data, to control a switching status of a flow valve of the external cooling air supply device, so as to increase or decrease a circulation speed of cooling gas in the heat dissipation unit.

In some embodiments, the monitoring unit may periodically measure a core temperature of the molten glass inside the platinum channel (1) via a temperature sensor and upload the collected temperature data to the control unit via a wired or wireless manner.

After receiving the temperature data, the control unit performs calculation and analysis according to a preset control strategy and algorithm. For example, the control unit compares the temperature data of the molten glass monitored in real time with a target temperature value, calculates a difference, and uses a control algorithm to determine a required adjustment amount for a flow rate of the cooling gas.

In some embodiments, the control unit generates and outputs a control instruction based on an analysis result to adjust the switching status of the flow valve of the external cooling air supply device. For example, when the temperature data of the molten glass is higher than a set value, the control unit issues an instruction to increase an opening degree of the flow valve, thereby increasing the flow rate and the circulation speed of the cooling gas. Conversely, when the temperature data is lower than the set value, the opening degree of the flow valve is reduced. Increasing or decreasing the circulation speed of the cooling gas in the heat dissipation unit directly affects an efficiency of the heat dissipation unit in removing heat. For example, when a flow velocity of the cooling gas increases, the gas flowing through the internal cooling assembly is capable of absorbing and carrying away heat transferred from the platinum channel more quickly, thereby achieving a stronger cooling effect.

In some embodiments, the control unit may also perform calculation, analysis, and control in various other ways. For example, an adaptive control algorithm may be adopted, or predictive control may be performed based on historical data and a physical model, which is not limited herein.

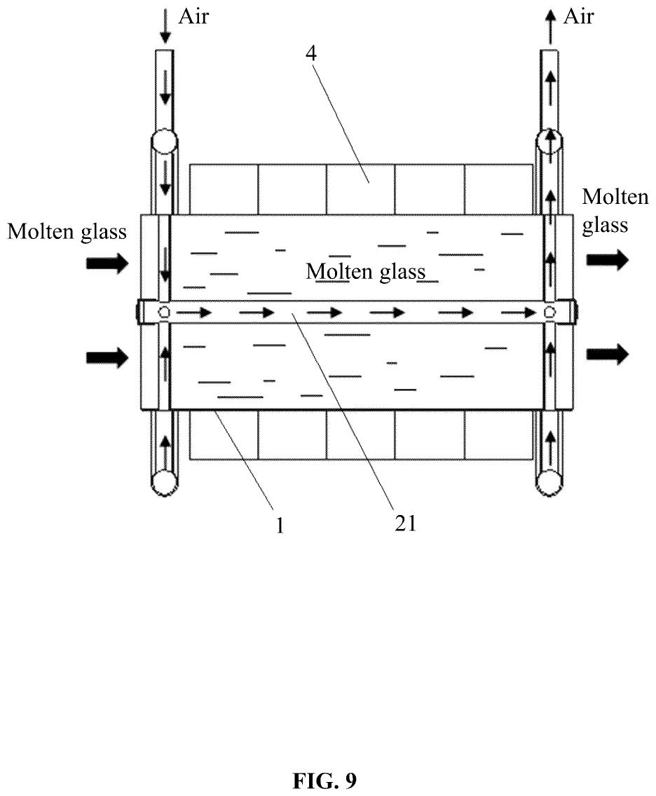

FIG. 9 is a cross-sectional schematic diagram of cooling principle of the platinum channel according to some embodiments of the present disclosure.

As shown in FIG. 9, the cooling gas enters from an inlet pipe, passes through the annular pipe (31), and is uniformly transmitted into an internal circulating cooling pipe (2) to directly carry away heat inside the molten glass. The cooling gas after heat exchange may flow out from an external connecting pipe (33) on a side of the air outlet (25). The cooling gas may be continuously supplied by a kinetic energy system (i.e., the external cooling air supply device). The flow rate of the cooling gas may be monitored in real time by installing a flow meter. A temperature difference may be determined by continuously monitoring temperatures of an inlet airflow and an outlet airflow via the plug-in thermocouple (5). Combined with a temperature measured by the welded thermocouple (6) on the platinum channel (1), an external control unit (e.g., a distributed control system) may automatically adjust the flow rate of the cooling gas and the temperature of the inlet airflow. For a temperature inside the molten glass, a core temperature of the molten glass may be monitored by using the plug-in thermocouple (5) on the platinum channel (1), thereby controlling an entire cooling process of the molten glass.

In some embodiments of the present disclosure, by executing the heat dissipation process according to the above manner, the heat dissipation efficiency can be effectively increased by 1 to 3 times. For glass production lines with larger sizes and larger flow rates, it can achieve efficient heat dissipation and ensure that an internal-external temperature difference of the molten glass is controlled within 5° C. Compared to an original internal-external temperature difference of 30° C. to 60° C., the improvement in the internal-external temperature difference of the molten glass is relatively significant, providing an excellent fundamental condition for uniform overflow of the molten glass and also providing a good foundation for subsequent glass processing, and having good practical significance.

In some embodiments, the control unit may generate a temperature variation difference among different molten glass regions of the molten glass in the platinum channel based on temperature field matrix data obtained by the grating sensor or the infrared array sensor in different regions; determine a flow valve adjustment amount of the external cooling air supply device based on the temperature variation difference; and control the flow valve to adjust a valve opening degree based on the flow valve adjustment amount, to adjust the flow rate or the flow velocity of the cooling gas.

The grating sensor (e.g., FBG) or the infrared array sensor may be used to obtain radial and axial temperature field data of the molten glass in the platinum channel (1) or obtain the temperature data of the cooling gas. The grating sensor, arranged at a specific depth or position (e.g., an outer wall of a main cooling pipe or a flow guide vane, or inside a circulating cooling pipe), can achieve distributed temperature measurement. The infrared array sensor performs non-contact temperature field scanning on a surface or a near-surface of the molten glass.

In some embodiments, the grating sensor or the infrared array sensor monitors the temperature data at a high frequency (e.g., once per second) and uploads high-density temperature data to the control unit (e.g., the distributed control system). The control unit receives the high-density temperature data and generates the temperature field matrix data of the molten glass in real time.

The temperature field matrix data may be a data set including sensor coordinates, or a molten glass region, or a sensor number, and a corresponding temperature and time.

The temperature variation difference refers to a real-time temperature difference in a radial direction inside the platinum channel or in an axial direction of the platinum channel. The temperature variation difference may reflect a degree of uneven heat dissipation.

In some embodiments, the control unit may determine a difference between temperatures corresponding to different coordinates, or molten glass regions, or sensor numbers at the same time as the temperature variation difference. For example, the control unit determines the temperature variation difference based on a plurality of temperatures corresponding to the radial direction inside the platinum channel or determines the temperature variation difference based on a plurality of temperatures corresponding to the axial direction of the platinum channel.

The flow valve adjustment amount of the external cooling air supply device refers to an increase or decrease value by which an opening degree of the flow valve needs to be adjusted. The flow valve adjustment amount of the external cooling air supply device may be calculated based on the temperature variation difference.

In some embodiments, the control unit may input the temperature variation difference into a PID-based feedback control algorithm; and calculate a currently required flow valve adjustment amount (e.g., +5% valve opening degree) with a preset temperature difference target value (e.g., less than 1° C.) as a target. The temperature variation difference may serve as a feedback value, and the flow valve adjustment amount serves as an output value.

In some embodiments, the control unit may determine the flow valve adjustment amount by performing retrieval in a vector database based on the temperature field matrix data and the temperature variation difference. The vector database includes a plurality of candidate vectors and corresponding flow valve adjustment amounts. The candidate vector includes information such as the temperature field matrix data (including the molten glass region, the sensor number) and the temperature variation difference. The vector database may be constructed based on historical data. For example, based on a large amount of historical glass production data, when a temperature variation difference of the molten glass exceeds a preset difference threshold, the flow valve adjustment amount is adjusted to subsequently reduce the temperature variation difference below the preset difference threshold, then the flow valve adjustment amount or an average value of the flow valve adjustment amounts is used as the flow valve adjustment amount corresponding to data such as the temperature variation difference in the vector database. The control unit may construct a retrieval vector based on a current temperature field matrix uploaded by the grating sensor or the infrared array sensor; retrieve and determine a candidate vector with a maximum similarity (e.g., a shortest vector distance) to the retrieval vector in the vector database; and use the flow valve adjustment amount corresponding to the candidate vector as the determined flow valve adjustment amount.

In some embodiments, the control unit controls, via a digital or analog signal, the flow valve on the external cooling air supply device to immediately adjust the valve opening degree according to the determined flow valve adjustment amount, thereby precisely and quickly changing the flow rate or the flow velocity of the cooling gas inside the circulating cooling pipe (2).

In some embodiments of the present disclosure, by determining the flow valve adjustment amount based on the temperature variation difference, it can achieve real-time and high-precision closed-loop feedback control based on the temperature field difference, significantly improving a response speed and a control precision of the heat dissipation unit, and quickly eliminating radial temperature differences.

In some embodiments, the control unit may predict future temperature field matrix data of the molten glass in the platinum channel (1) based on temperature field matrix data at a plurality of time points; determine an advance adjustment amount for the flow valve of the external cooling air supply device based on the future temperature field matrix data; and control the flow valve in advance to adjust the valve opening degree based on the advance adjustment amount for the flow valve.

The temperature field matrix data at the plurality of time points refers to temperature field matrix data obtained by high-density sensors within a current time period and a past time period.

The future temperature field matrix data refers to temperature data of the molten glass at a future time, i.e., the temperature field matrix data at the future time. Data nodes of the temperature field matrix data and the future temperature field matrix data are formed by the grating sensor or the infrared array sensor.

Predicting the future temperature field matrix data of the molten glass in the platinum channel refers to predicting temperature distribution of the molten glass at different sensor nodes or different molten glass regions at one or more future times. For example, at a future time t+n*k, such as t+1*0.5 minutes, t+2*0.5 minutes, or the like. n and k are preset manually. A prediction output result is future temperature field matrix data with high spatial resolution, and the spatial coordinates correspond one-to-one with spatial coordinates of an actual sensor array (i.e., corresponding to different molten glass regions), thereby ensuring that the prediction result can directly guide precise control of the flow valve.

In some embodiments, the control unit may continuously run a temperature field prediction model to generate temperature field matrix data at a future time. The temperature field prediction model refers to a model used for predicting the future temperature field matrix data. In some embodiments, the temperature field prediction model is a machine learning model, for example, a neural network (NN) model, a recurrent neural network (RNN) model, a long short-term memory network (LSTM) model, or other custom models, or any combination thereof.

In some embodiments, an input of the temperature field prediction model may include the flow rate and a temperature of the cooling gas at a current time, the flow velocity of the molten glass, and the temperature field matrix data. An output of the temperature field prediction model may include the predicted future temperature field matrix data.

In some embodiments, the temperature field prediction model may be obtained through training based on training data. In some embodiments, the control unit may obtain a first training sample set including a plurality of first training samples with first labels and perform a plurality of rounds of iterations based on the first training sample set.

The first training sample may include a sample flow rate and a sample temperature of the cooling gas, a sample flow velocity of the molten glass, and sample temperature field matrix data. The first label is the predicted future temperature field matrix data. The first training sample may be constructed based on a large amount of historical glass production data. The first label may be determined based on actual monitored temperature field matrix data at a future time corresponding to the training sample in the large amount of historical production data.

In some embodiments, the processor may input the first training sample set into an initial temperature field prediction model to perform the plurality of rounds of iterations. Each round of iterations includes: selecting one or more first training samples from the first training sample set; inputting the one or more first training samples into the initial temperature field prediction model, obtaining one or more model prediction outputs corresponding to the one or more first training samples; substituting the one or more model prediction outputs corresponding to the one or more first training samples and the first labels of the one or more first training samples into a formula of a predefined loss function to calculate a value of the loss function; and iteratively updating model parameters of the initial temperature field prediction model based on the value of the loss function. When an iteration end condition is satisfied, the iteration is ended to obtain the trained temperature field prediction model. The iteration end condition may be that the loss function converges, a count of iterations reaches a threshold, or the like.

In some embodiments, the output of the temperature field prediction model may further include a confidence corresponding to the future temperature field matrix data. The first label may also include the confidence corresponding to the predicted future temperature field matrix data. The confidence may be determined according to a ratio of a count of occurrences of actual monitored temperature field matrix data within a same range (a range interval may be preset manually) to a total count of occurrences.

The advance adjustment amount for the flow valve of the external cooling air supply device refers to an adjustment amount by which the flow valve of the external cooling air supply device needs to be adjusted in advance at a current time.

In some embodiments, the control unit may calculate a predicted temperature difference at a future time according to the predicted future temperature field matrix data; and determine the advance adjustment amount based on the predicted temperature difference. For example, the control unit may select one or a plurality of pieces of future temperature field matrix data with a highest or higher confidence, and calculate, based on a preset algorithm, an advance adjustment amount required to cause a corresponding predicted temperature difference to be below a preset difference threshold at a time t+k. t is a current time, and k is preset manually. The advance adjustment amount takes into account a time lag and dynamic response characteristics of an entire cooling system.

In some embodiments, the control unit may determine the flow valve adjustment amount by retrieving from a vector database. More descriptions regarding determining the flow valve adjustment amount by retrieving from the vector database may be found above.

In some embodiments, the control unit may determine the advance adjustment amount according to n value preset manually above based on the flow valve adjustment amount, and the advance adjustment amount is the flow valve adjustment amount divided by n. n is n in the future time corresponding to the future temperature field data selected by the control unit, for example, n corresponding to the future time with the highest confidence. The preset algorithm is to divide the flow valve adjustment amount by n to obtain the advance adjustment amount.

In some embodiments, the control unit may control the flow valve in advance to adjust a valve opening degree at the current time t according to the advance adjustment amount. For example, if it is predicted that a temperature difference will expand in 5 minutes, the control unit may immediately perform a flow increase operation at the current time t, instead of waiting until the temperature difference expands after 5 minutes to perform a related operation.

In some embodiments of the present disclosure, the advance adjustment amount is determined by predicting the future temperature field matrix data, achieving predictive feedforward control, effectively overcoming lag caused by thermal inertia, avoiding problems of over-cooling or insufficient adjustment common in traditional feedback control, and improving temperature control accuracy to an extremely high level.

In some embodiments, the control unit may further obtain gas temperature data of the cooling gas in the circulating cooling pipe (2) of different pipe regions; generate a cooling effect of the molten glass in different molten glass regions based on differences in the gas temperature data of the different pipe regions; and determine an initial gas temperature of the cooling gas based on the cooling effect, and control the external cooling air supply device to produce the cooling gas based on the initial gas temperature.

In some embodiments, the gas temperature data of the cooling gas in the circulating cooling pipe of the different pipe regions refers to a temperature of the cooling gas obtained in real time by the grating sensor (e.g., FBG) or the infrared array sensor arranged at different internal axial positions of the circulating cooling pipe (2) (e.g., the air inlet (24), a middle section, the air outlet (25)).

The cooling effect of the molten glass in the different molten glass regions refers to an efficiency of the cooling gas in removing heat from the molten glass as the cooling gas flows through the different molten glass regions of the platinum channel (1). For example, if a difference between a temperature increase amplitude of the cooling gas and a preset temperature threshold corresponding to the pipe region is large (for example, exceeding or lower than the preset temperature threshold by 10%, 20%, 30%, etc.), it indicates that the efficiency of the cooling gas in removing heat from the molten glass in the pipe region is low, and there may be a problem of insufficient cooling or over-cooling. The preset temperature threshold may be preset manually based on experience.

The initial gas temperature of the cooling gas refers to a set inlet temperature of the cooling gas delivered by the external cooling air supply device to the internal cooling assembly (2). In some embodiments, the external cooling air supply device may be provided with a refrigeration component and/or a heating component to achieve gas temperature adjustment.

In some embodiments, the control unit may evaluate the cooling effect of the molten glass in the different molten glass regions in a plurality of ways. For example, the control unit may monitor the gas temperature data of different pipe regions in an axial direction of the platinum pipeline in real time and determine the cooling effect of the molten glass in the different molten glass regions according to a difference between the gas temperature of the different pipe regions and a preset temperature threshold.

In some embodiments, the control unit may determine the cooling effect of the molten glass in the different molten glass regions according to the gas temperature corresponding to the pipe region and the preset temperature threshold. For example, the control unit may also determine the cooling effect of the molten glass in the different molten glass regions according to the following formula (1).

$$e = 1 + \frac{{t}_{r} - {t}_{p}}{{t}_{p}} , \qquad ( 1 )$$

where tᵣ denotes a gas temperature corresponding to a pipe region, tₚ denotes a preset temperature threshold, e denotes the cooling effect of the molten glass, and the above parameters are all dimensionless values.

In some embodiments, the control unit may determine the initial gas temperature of the cooling gas according to a plurality of ways. For example, the control unit may determine the initial gas temperature of the cooling gas according to a preset rotation speed. More descriptions regarding the preset rotation speed may be found in related description below.

The control unit may determine the initial gas temperature of the cooling gas according to a preset speed table. The speed table includes an interval range (e.g., −15° C. to −8° C.) of the initial gas temperatures corresponding to different preset rotation speeds. The preset speed table may be determined according to historical glass production data. For example, according to a large amount of historical glass production data, an average value of intervals of the initial gas temperatures when the cooling effect of the molten glass meets requirements (e.g., a temperature difference is lower than a preset difference threshold, the cooling effect is greater than a preset effect threshold, etc.) under different preset rotation speeds is used as the interval range of the initial gas temperatures corresponding to the preset rotation speeds in the preset speed table.

In some embodiments, if there is an uneven temperature distribution in an axial direction of the platinum channel (i.e., an uneven cooling effect), the control unit may adjust the initial gas temperature of the cooling gas according to the cooling effect. For example, if there is a problem of overcooling of the molten glass at a front end of the platinum channel, the initial gas temperature may be increased to save energy consumption. As another example, if there is an overall insufficient cooling of the molten glass in the platinum channel, the initial gas temperature may be decreased to enhance an overall heat transfer temperature difference.

In some embodiments, the control unit may also divide the initial gas temperature by the cooling effect to obtain an adjusted initial gas temperature.

An adjustment range of the initial gas temperature of the cooling gas may have upper and lower limits, such as ±8° C. The upper and lower limits of the adjustment range may be preset by a person according to experience.

In some embodiments, in addition to controlling the flow valve, the control unit may also control a refrigeration component and/or a heating component of the external cooling air supply device, so that the external cooling air supply device produces and delivers the cooling gas according to the initial gas temperature.

In some embodiments of the present disclosure, by adding a cooling medium temperature as a regulation dimension, dual-variable coordinated control of temperature and flow rate can be achieved, which can more finely balance the axial heat dissipation load, and according to characteristics of the molten glass, the initial gas temperature is used to suppress platinum oxidation volatilization of the platinum channel, thereby extending a service life.

It should be noted that the foregoing description of the process 800 is for the purpose of explanation and illustration only and does not limit the scope of application of the present disclosure. For those skilled in the art, various corrections and changes can be made to the process 800 under the guidance of the present disclosure. However, these corrections and changes remain within the scope of the present disclosure.

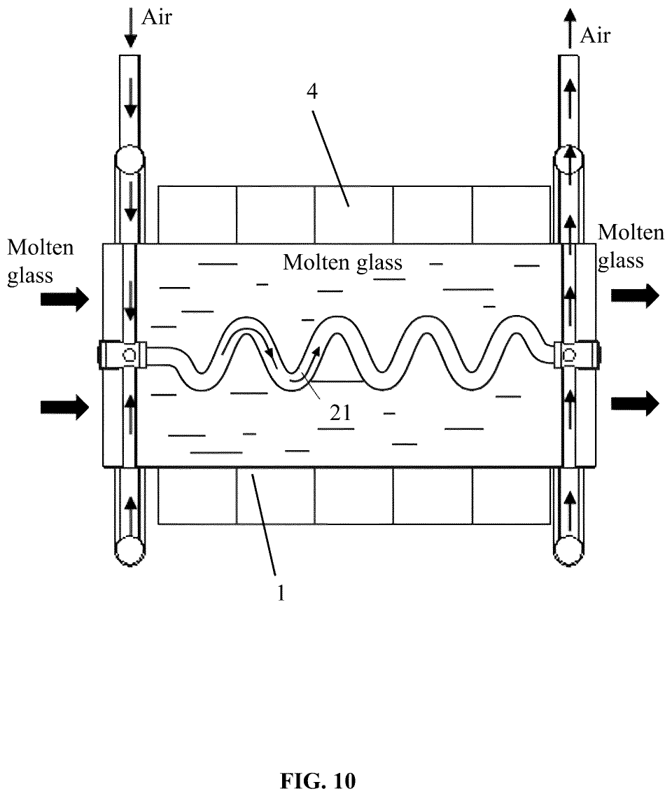

FIG. 10 is another cross-sectional schematic diagram of the cooling principle of the platinum channel according to some embodiments of the present disclosure.

In some embodiments, as shown in FIG. 10, the main cooling pipe (21) may be configured as a helical flow guide pipe.

The flow guide pipe refers to a pipe used to guide a flow of a medium (e.g., the molten glass). The helical structure increases an effective heat transfer area and a residence time of the cooling gas in the main cooling pipe (21), thereby more efficiently absorbing and carrying away heat of the platinum channel (1).

Parameters of the helical flow guide pipe (e.g., a diameter of a helix, a pitch, etc.) may be optimally designed according to specific heat dissipation requirements and the temperature distribution of the molten glass. For example, the diameter of the helix may be 30%-80% of the width or the diameter of the platinum channel, and the pitch of the helix may be 10%-20% of the length of the platinum channel.

By adjusting the parameters of the flow guide pipe, it can achieve precise control of the flow velocity and a turbulence degree of the cooling gas, thereby achieving a more uniform or targeted cooling effect along the length direction of the platinum channel (1).

In some embodiments of the present disclosure, by configuring the main cooling pipe (21) as the helical flow guide pipe, the cooling gas flows in a helical path in the flow guide pipe, which significantly increases the heat exchange area and the residence time between the cooling gas and the channel, thereby greatly improving the heat dissipation efficiency and enhancing the heat exchange effect. Meanwhile, while the cooling gas carries away central heat, the helical groove can induce the molten glass to generate secondary flow or vortex flow, achieving automatic stirring and homogenization of the molten glass and breaking through the limitation of cooling relying solely on heat diffusion.

FIG. 11 is another cross-sectional schematic diagram of the cooling principle of the platinum channel according to some embodiments of the present disclosure.

In some embodiments, as shown in FIG. 11, the main cooling pipe (21) may comprise flow guide vanes.

The flow guide vane refers to a blade-shaped structure used to guide flow of a medium or enhance heat exchange. For example, the flow guide vane may be fixed on an outer wall of the main cooling pipe (21) to change the flow direction of the molten glass and promote full contact between the molten glass and the pipe wall of the main cooling pipe (21), thereby improving the heat exchange efficiency. The flow guide vanes may be arranged in a helical or radial distribution to generate vortex flow or increase the effective heat transfer area.

Parameters of the flow guide vane (e.g., a shape, a size, a quantity, and an arrangement manner on the main cooling pipe (21)) may be optimally designed according to the type of the cooling gas, the flow rate, and the required heat dissipation effect. For example, the flow guide vanes are distributed uniformly or non-uniformly along the axial direction on the outer wall of the main cooling pipe (21). A quantity of the flow guide vanes may be 2, 3, 5, 8, 10, or the like.

By adjusting the parameters of the flow guide vanes, an airflow velocity distribution and a heat transfer efficiency can be controlled.

In some embodiments, the flow guide vanes may also be disposed on the outer wall of the main cooling pipe (21) in a plurality of other ways. For example, the flow guide vanes may be designed as radially distributed straight blades, wavy structures, or honeycomb structures to meet different cooling and fluid guidance requirements.

In some embodiments of the present disclosure, by disposing the flow guide vanes inside the main cooling pipe, a flow state of the cooling airflow is effectively organized and optimized, changing disordered flow into efficient and uniform turbulent flow or swirling flow and strengthening the convective heat transfer process, thereby improving overall cooling efficiency and ensuring uniformity of the temperature field of the platinum channel.

In some embodiments, the main cooling pipe (21) may be configured as a component rotatable around a pipe central axis, and the rotation is driven by a matching motor; and the control unit may control the matching motor to drive the main cooling pipe (21) to rotate at the preset rotation speed.

The pipe central axis refers to a central axis of the main cooling pipe (21). The main cooling pipe (21) is installed via a bearing or a rotating shaft, so that the main cooling pipe (21) can rotate around its own pipe central axis. For example, the matching motor is mechanically coupled to the main cooling pipe (21) via a gear, a belt, or a direct coupling to provide rotational power to the main cooling pipe (21). The matching motor may comprise a direct current (DC) motor, an alternating current (AC) motor, a stepper motor, or the like.

In some embodiments, the preset rotation speed may be set by a worker based on experience. For example, according to a type of the molten glass, the flow rate of the molten glass, and the required temperature uniformity, the worker may input an empirical rotation speed (e.g., 5-50 RPM) to ensure that the molten glass can be uniformly mixed, effectively avoiding temperature stratification.

In some embodiments, the preset rotation speed may also be dynamically adjusted by the control unit after performing calculation and analysis on real-time monitored temperature data of the molten glass, to optimize the cooling effect and maintain a specific temperature uniformity target. For example, if the temperature variation difference calculated according to the temperature field matrix data or the future temperature field matrix data is relatively large, the preset rotation speed may be increased; otherwise, the preset rotation speed may be decreased.

In some embodiments of the present disclosure, by designing the main cooling pipe (21) as a rotatable component and controlling the matching motor by the control unit to drive the main cooling pipe (21) to rotate at the preset speed, internal mixing and convective heat transfer of the molten glass are significantly enhanced, which can ensure uniform mixing of the molten glass to avoid temperature stratification, further optimizing the heat dissipation efficiency, and ultimately improving the glass product quality and production stability.

In some embodiments, the control unit may dynamically adjust the preset rotation speed based on a temperature variation difference obtained by analyzing the temperature field matrix data or the future temperature field matrix data.

More descriptions regarding the temperature field matrix data, the future temperature field matrix data, and the temperature variation difference may be found in FIG. 8 and related descriptions thereof.

In some embodiments, the control unit may adjust the preset rotation speed in various ways. The control unit may determine the adjusted preset rotation speed based on the preset rotation speed before adjustment, the temperature variation difference, and an average value of temperatures of the molten glass at a boundary and a center of the platinum channel.

For example, the control unit may adjust the preset rotation speed according to the following formula (2).

$${v}_{a} = {v}_{b} * ( 1 + \frac{Δ t}{{t}_{a}} ) , \qquad ( 2 )$$

where vₐ denotes the adjusted preset rotation speed, v_{b} denotes the preset rotation speed before adjustment, Δt denotes the temperature variation difference, tₐ denotes the average value of the temperatures of the molten glass at the boundary and the center of the platinum channel, and the above parameters are all dimensionless values.

In some embodiments of the present disclosure, by dynamically adjusting the preset rotation speed based on the temperature variation difference obtained by analyzing the temperature field matrix data or the future temperature field matrix data, it can achieve dynamic, proactive, and adaptive adjustment of the preset rotation speed, improving the overall cooling effect of the molten glass and reducing the internal temperature difference of the molten glass.

In some embodiments, the control unit may also determine the adjusted preset rotation speed through a speed model.

The speed model refers to a model configured to adjust the preset rotation speed. In some embodiments, the speed model is a machine learning model, for example, a NN model, an RNN model, an LSTM model, or other custom models, or any combination thereof.

In some embodiments, an input of the speed model may include the preset rotation speed before adjustment, the temperature field matrix data, and flow velocities of the molten glass in different molten glass regions. An output of the speed model may include the adjusted preset rotation speed. The flow velocities of the molten glass in the different molten glass regions may be determined by monitoring through a flow velocity sensor of the monitoring unit.

More descriptions regarding the temperature field matrix data may be found in FIG. 8 and related descriptions thereof.

In some embodiments, the speed model may be obtained through training based on training data. In some embodiments, the control unit may obtain a second training sample set including a plurality of second training samples with second labels and perform a plurality of rounds of iterations based on the second training sample set. The training process of the speed model is similar to the training process of the temperature field prediction model and is not repeated here.

The second training sample may be constructed based on a large amount of historical glass production data. The second training sample may include a sample preset rotation speed before adjustment, sample temperature field matrix data, and sample flow velocity of the molten glass. The second label is the adjusted preset rotation speed corresponding to the second training sample. For example, when the temperature difference of different molten glass regions is reduced below a preset difference threshold after actually adjusting the preset rotation speed under conditions similar to the second training sample, an average value of the actually applied adjusted preset rotation speeds is used as the second label corresponding to the second training sample. More descriptions regarding the preset difference threshold may be found in FIG. 8 and related descriptions thereof.

In some embodiments of the present disclosure, by determining the adjusted preset rotation speed through the speed model, the self-learning capability of the machine learning model can be utilized to find patterns from a large amount of historical data, improving the accuracy and efficiency of determining the adjusted preset rotation speed, and enhancing the precision of apparatus control, the adaptability of the apparatus, the maximization of cooling energy efficiency, and the stability of the cooling process.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure and are within the spirit and scope of the exemplary embodiments of this disclosure.

Moreover, certain terminology has been used to describe embodiments of the present disclosure. For example, the terms “one embodiment,” “an embodiment,” and “some embodiments” mean that a particular feature, structure, or feature described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures, or features may be combined as suitable in one or more embodiments of the present disclosure.

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose and that the appended claims are not limited to the disclosed embodiments, but, on the contrary, are intended to cover modifications and equivalent arrangements that are within the spirit and scope of the disclosed embodiments. For example, although the implementation of various parts described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claimed subject matter may lie in less than all features of a single foregoing disclosed embodiment.

In some embodiments, numbers describing the number of ingredients and attributes are used. It should be understood that such numbers used for the description of the embodiments use the modifier “about”, “approximately”, or “substantially” in some examples. Unless otherwise stated, “about”, “approximately”, or “substantially” indicates that the number is allowed to vary by ±20%. Correspondingly, in some embodiments, the numerical parameters used in the description and claims are approximate values, and the approximate values may be changed according to the required features of individual embodiments. In some embodiments, the numerical parameters should consider the prescribed effective digits and adopt the method of general digit retention. Although the numerical ranges and parameters used to confirm the breadth of the range in some embodiments of the present disclosure are approximate values, in specific embodiments, settings of such numerical values are as accurate as possible within a feasible range.

For each patent, patent application, patent application publication, or other materials cited in the present disclosure, such as articles, books, specifications, publications, documents, or the like, the entire contents of which are hereby incorporated into the present disclosure as a reference. The application history documents that are inconsistent or conflict with the content of the present disclosure are excluded, and the documents that restrict the broadest scope of the claims of the present disclosure (currently or later attached to the present disclosure) are also excluded. It should be noted that if there is any inconsistency or conflict between the description, definition, and/or use of terms in the auxiliary materials of the present disclosure and the content of the present disclosure, the description, definition, and/or use of terms in the present disclosure is subject to the present disclosure.

Finally, it should be understood that the embodiments described in the present disclosure are only used to illustrate the principles of the embodiments of the present disclosure. Other variations may also fall within the scope of the present disclosure. Therefore, as an example and not a limitation, alternative configurations of the embodiments of the present disclosure may be regarded as consistent with the teaching of the present disclosure. Accordingly, the embodiments of the present disclosure are not limited to the embodiments introduced and described in the present disclosure explicitly.

What is claimed is:

1. A heat dissipation apparatus for molten glass in a platinum channel, comprising an apparatus body and a control unit disposed on the apparatus body, wherein the apparatus body comprises a heat dissipation unit and a monitoring unit, and the monitoring unit and the heat dissipation unit are installed on a pipe section of the platinum channel, wherein
the heat dissipation unit comprises an internal cooling assembly and an external air-guiding assembly, the external air-guiding assembly is capable of connecting to an external cooling air supply device, so that the control unit controls a flow rate of the external cooling air supply device according to temperature data of the molten glass monitored by the monitoring unit, to control a temperature of the molten glass in the pipe section of the platinum channel; an
the internal cooling assembly comprises a circulating cooling pipe disposed inside the platinum channel, the circulating cooling pipe is provided with an air inlet and an air outlet, pipe sections of the air inlet and the air outlet extend through and out of the platinum channel and are conductively connected to the external air-guiding assembly, the external air-guiding assembly is provided with an external connecting pipe, and the external connecting pipe is used for connecting to the external cooling air supply device.

2. The heat dissipation apparatus for the molten glass in the platinum channel according to claim 1, wherein the circulating cooling pipe comprises a main cooling pipe arranged inside the platinum channel along an axial direction, the main cooling pipe is conductively connected to at least one branch cooling pipe at positions close to two ends of the main cooling pipe, the air inlet is disposed at an end of a branch cooling pipe away from the main cooling pipe, and the branch cooling pipe extends through and out of an outer wall of the platinum channel.

3. The heat dissipation apparatus for the molten glass in the platinum channel according to claim 2, wherein two ends of the main cooling pipe are provided with end sealing caps, and the end sealing caps are used for sealing the main cooling pipe along the axial direction.

4. The heat dissipation apparatus for the molten glass in the platinum channel according to claim 2, wherein four branch cooling pipes are provided, and the four branch cooling pipes are arranged at intervals along a circumferential direction of the main cooling pipe.

5. The heat dissipation apparatus for the molten glass in the platinum channel according to claim 1, wherein a material of the circulating cooling pipe is the same as a material of the platinum channel.

6. The heat dissipation apparatus for the molten glass in the platinum channel according to claim 1, wherein the external air-guiding assembly comprises an air duct assembly, the air duct assembly comprises two annular pipes, each of the two annular pipes is provided with shunt pipes along a radial direction of the annular pipe, the shunt pipes located at the two annular pipes are conductively connected to the air inlet and the air outlet, respectively, and each of the two annular pipe is provided with the external connecting pipe along a side wall of the annular pipe.

7. The heat dissipation apparatus for the molten glass in the platinum channel according to claim 6, wherein a plurality of apparatus bodies are provided, and the plurality of apparatus bodies are arranged along the axial direction of the platinum channel.

8. The heat dissipation apparatus for the molten glass in the platinum channel according to claim 1, wherein the monitoring unit comprises at least one plug-in thermocouple and at least one welded thermocouple configured on the platinum channel.

9. The heat dissipation apparatus for the molten glass in the platinum channel according to claim 1, wherein the control unit comprises a distributed control system, and the distributed control system controls the flow rate of the external cooling air supply device according to monitoring data uploaded by the monitoring unit.

10. A heat dissipation method for molten glass in a platinum channel, wherein the method is applied to the heat dissipation apparatus for the molten glass in the platinum channel of claim 1, and the method comprises:
installing the internal cooling assembly and the external air-guiding assembly on the platinum channel, checking tightness, checking integrity of the monitoring unit, and connecting the external air-guiding assembly to the external cooling air supply device;
turning on the external cooling air supply device, and simultaneously controlling the monitoring unit and the control unit to operate; and
monitoring, by the monitoring unit, the temperature data of the molten glass in real time and uploading the temperature data to the control unit, and performing, by the control unit, calculation and analysis according to the temperature data, to control a switching status of a flow valve of the external cooling air supply device, so as to increase or decrease a circulation speed of cooling gas in the heat dissipation unit.
